(19) United States
(12) Patent Application Publication
(10) Pub. No.: US 2006/0193101 A1
(43) Pub. Date: Aug. 31, 2006

(54) Electrostatic chuck and vacuum processing apparatus provided with the same

(76) Inventors: Koji Sogabe, Susono-shi (JP); Yasunori Danjo, Susono-shi (JP)

Correspondence Address: Floyd B. Carothers;CAROTHERS AND CAROTHERS, Suite 500, 445 Fort Pitt Boulevard, Pittsburgh, PA, 15219, US

(21) Appl. No.: 11/362,380

(22) Filed: Feb. 24, 2006

(30) Foreign Application Priority Data
Feb. 25, 2005 (JP) 2005-050921

(51) Int. Cl. H01T 23/00

(52) U.S. Cl. 361/234

(57) ABSTRACT

An intermediate body 19 is interposed between the hot plate 17 and the stage 18. The contact surfaces of the hot plate 17 and intermediate body 19 are less than 10 nm in surface roughness. The hot plate 17 and the intermediate body 19 are directly contacted with each other. Secure sealing can be obtained between the hot plate 17 and the intermediate body 19 without using heat-endurable seal material. The heat transfer gas is prevented from leaking from the contact surfaces of the hot plate 17 and intermediate body 19. The result is that the construction is simplified, the manufacturing cost is low, the maintenance is good and sealability of the heat transfer gas can be secured.

### BACKGROUND OF THE INVENTION

1. Field of the Invention

This invention relates to an electrostatic chuck and a vacuum processing apparatus provided with the same for semiconductor manufacturing.

2. Description of the Prior Art

Semiconductors have developed typically on the miniaturizing of the design rule and on the large-sizing of the wafer. A higher operating ratio of the semiconductor manufacturing apparatus is strongly demanded. To improve the yield rate of semiconductor tips from one wafer, it is important that the temperature of the wafer processed under the reduced pressure is maintained at constant. A heating plate having an electrostatic-attracting function is used as an effective means.

A spattering apparatus as one example of the semiconductor manufacturing apparatus, is provided with a processing chamber which is exhausted or evacuated to a predetermined pressure. A substrate supporting device or electrostatic chuck for attracting, heating and cooling a wafer, is provided in the processing chamber. When the hot plate is used in the process, the heat amount imparted to the wafer from the process and the heat amount supplied to the wafer from the heat plate should, on the balance, be considered. In the prior art, the attracting area of the wafer is designed to be the maximum permissible in consideration of the heat transfer between the wafer and the hot plate.

However, the fear of damage to the back surface of the wafer and of damage to the attracting surface of the hot plate increases with the attracting area of the wafer. Further, contaminants made by the friction between the wafer and hot plate are adhered to the walls of the processing chamber. Thus, the yield rate of the semiconductor tips is lowered.

In some cases, gas having a high heat transfer rate is sealed between the hot plate and the wafer for avoiding the above-mentioned disadvantages. Thus, the attracting area can be reduced and the temperature of the wafer can be so maintained at a constant. Generally, a mount made of metal (hereinafter, also called a stage) is joined with the hot plate. A gas supply path for heat transfer gas (back surface gas) is formed in the mount or the stage in order to control the temperature of the wafer. Further, an adapter or the like is arranged therein for introducing electric power necessary for heating, attracting and cooling the hot plate itself (refer to the below-mentioned patent literature 1).

The requirements for the stage are a predetermined vacuum sealing function between the stage and the vacuum processing chamber, a function to cool the hot plate with the circulation of cooling water, and a function to introduce back gas between the hot plate and the wafer without leaking to the processing chamber. In most cases, the stage is made mainly of metal since it should endure the range of high temperatures and can be easy to be manufactured. Further, it is provided with a high voltage circuit for supplying electric power to the heating mechanism (heater or the like) and the electrode of the electrostatic chuck assembled in the hot plate.

Patent Literature 1: JP2001-068538A

In the prior art electrostatic chuck, an O-ring is used as a sealing means between the processing chamber and the stage. On the other hand, endurance to heat and discharging gas should be considered for the sealing means between the hot plate and the stage since heat is transferred from the hot plate. Accordingly, an O-ring cannot be used. Therefore it can be considered that the hot metal and the stage be joined with each other by the soldering method and the metal bonding method.

However, thermal expansion coefficients of the hot plate made of ceramics and of the stage made of metal are greatly different from each other. Accordingly, when the hot plate and the stage are joined with each other by the soldering method and the metal bonding method, joint defects during the joining operation and cracks often occur. The yield rate is remarkably deteriorated. Further, also when the above-mentioned electro-static chuck is set in the semiconductor manufacturing apparatus, the above-mentioned disadvantages occur during the process. There is the fear that the processed device and the processed apparatus may be fatally damaged. Accordingly, it is required that materials substantially equal to each other in thermal expansion coefficient are selected for the hot plate and the stage, and that the temperature of the hot plate is so controlled whereby the thermal expansion difference between the hot plate and the stage becomes the minimum permissible.

Electrical power or mechanical power necessary for processing products in the processing chamber and circulating cooling water are introduced through the stage. Accordingly, when the hot plate is exchanged for maintenance, the power supply systems or lines should be disconnected from the stage. Accordingly, the down time of the manufacturing apparatus becomes long and the running cost increases.

On the other hand, an electrostatic chuck is advantageous wherein the hot plate and the stage are separate bodies and can be separated from each other. To improve the operating ratio of the manufacturing apparatus and the yield of the semiconductor devices, temperature control of the wafer is necessary and the uniformity of the coverage is required for a high aspect ratio. To raise the coverage, the product should be processed at lower pressure. On the other hand, the back surface gas pressure is required to be introduced between the wafer and the hot plate for securing the temperature control of the wafer. In that case, there is the fear that the back surface gas will leak into the processing chamber whereby the wafer cannot be processed.

To avoid the above-described disadvantage, a gas-leakless construction is required for the electrostatic chuck. However, such problems as a joint of different materials, heat endurance, mechanical strength and electrical insulation should be solved in that construction. The construction becomes complicated. The cost increases and the construction is large-sized.

In the above patent literature, for example, such an electrostatic chuck 1 as shown in FIG. 4 is disclosed. In the drawing, reference numeral 2 represents a hot plate into which heater 2A and an electrode (not shown) for electrostatic attraction are assembled. The reference numeral 3 represents a stage in which a cooling -water circulation path 3A is formed. The reference numeral 4 represents an intermediate body arranged between the hot plate 2 and the stage 3. The reference numeral 5 represents a metal seal arranged between the hot plate 2 and an intermediate body 4. The reference numeral 6 represents a metal seal arranged between the stage 3 and an intermediate body 4. The reference numeral 7 represents a gas flow path groove formed in the surface of the hot plate 2 for introducing heat-transfer gas (back surface gas) to the back surface of the wafer W. Reference numeral 8 represents a heat transfer space formed between the hot plate 2 and an intermediate body 4. The reference numeral 9 represents a heat transfer space formed between the stage 3 and an intermediate body 4. The reference numeral 10 represents a heat transfer gas supply tank for supplying the heat transfer gas into the gas flow supply groove 7 and the heat transfer spaces 8 and 9.

In the above prior art electrostatic chuck 11, the heat transfer spaces 8 and 9 are formed to reduce the heat resistance between the stage 3 and the hot plate 2. The heat transfer gas is introduced into the heat transfer spaces 8 and 9, respectively. The heat is exchanged between the stage 3 and the hot plate 2 through the heat transfer spaces 8 and 9 and the intermediate body 4.

Metal seals 5 and 6 are required to seal the heat transfer spaces 8 and 9 between the hot plate 2 and the intermediate body 4, and between the stage 3 and the intermediate body 4. Thus, the prior art electrostatic chuck is complicated in construction, maintenance operability is lowered, and part exchange might become frequent.

### SUMMARY OF THE INVENTION

Accordingly, it is an object of the invention to provide an electrostatic chuck, which is simple in construction, in which maintenance operability is improved and in which the sealability of the heat transfer gas can be secured.

It is another object of the invention to provide a vacuum processing apparatus, that is provided with an electrostatic chuck, which is simple in construction, in which maintenance operability is improved and in which the sealability of the heat transfer gas can be secured.

In accordance with an aspect of the invention, an electrostatic chuck is provided for attracting a substrate which is comprised of:
(A) a plate including an electrode for electrostatically attracting said substrate and a heating mechanism for heating said substrate,
(B) a stage for cooling said plate,
(C) an intermediate body interposed between said plate and said stage, a gas supply flow path formed in said plate, said intermediate body and said stage for supplying heat transfer gas to the surface of said plate, and
(D) at least the contact surfaces of said plate and said intermediate body being smaller than 10 nm in surface roughness.

In another aspect of the invention, a vacuum processing apparatus is comprised of:
(A) a vacuum processing chamber,
(B) an electrostatic chuck arranged in said vacuum chamber for attracting a substrate,
(C) vacuum processing means for effecting a predetermined vacuum process to said substrate,
(D) said electrostatic chuck including:
   (a) a plate provided with an electrode for electrostatically attracting said substrate and a heating mechanism for heating said substrate;
   (b) a stage for cooling said plate;
   (c) an intermediate body interposed between said plate and said stage;
   (d) a gas supply flow path formed in said plate, said intermediate body and said stage for supplying heat transfer gas to the surface of said plate, and
   (e) at least the contact surfaces of said plate and intermediate body being smaller than 10 nm in surface roughness.

According to this embodiment, the plate and the intermediate body are directly contacted with each other. No seal material endurable to heat is required. A predetermined sealing function can be secured between the plate and the intermediate body. Leakage of heat transfer gas through the contact surfaces of the plate and intermediate body to the outside can be much suppressed. The construction is simplified. It requires low cost. At the surface of 10 nm, the sealing has little influence on the process pressure, for example, at least 1×10⁻⁵ Pa. Under surface roughness 10 nm, sealing can be further obtained in a higher degree of vacuum.

Similarly, the contact surfaces between the stage and the intermediate body which directly contact each other may be less than 10 nm in surface roughness. Thus, a predetermined sealability can be obtained also between the stage and the intermediate body. Since the heat is not transferred directly from the plate side, as occasion demands, an O-ring may be interposed between the stage and the intermediate body to secure the sealability. The material of the intermediate body is not limited. Metal or electric insulating material may be used. Particularly, silica, aluminum, zirconia, etc. may be used as the insulating material. They are superior in heat-transferability. The plate, the intermediate body and the stage are joined together with each other through a fixing jig. Normal bolts can be used as the fixing jig. Thus, they can be easily separately demounted and exchanged.

According to this invention, as above described, leakage of the heat transfer gas through the contacted surfaces between the plate and the stage can be suppressed. The electrostatic chuck can be simple in construction, and maintenance operation can be improved.

The foregoing and other objects, features and advantages of the present invention will be more readily understood upon consideration of the following detailed description of the preferred embodiments of the invention, taken in conjunction with the accompanying drawings.

### BRIEF DESCRIPTION OF THE DRAWINGS

FIG. 1 is a schematic view of an outline of a vacuum processing apparatus according to an embodiment of this invention;

FIG. 2 is a cross-sectional side view of an electrostatic chuck according to an embodiment of this invention;

FIG. 3 is an experimental chart for explaining the sealability of the electro-static chuck.

FIG. 4 is a side cross-sectional view of a prior art electrostatic chuck.

### DESCRIPTION OF THE PREFERRED EMBODIMENTS

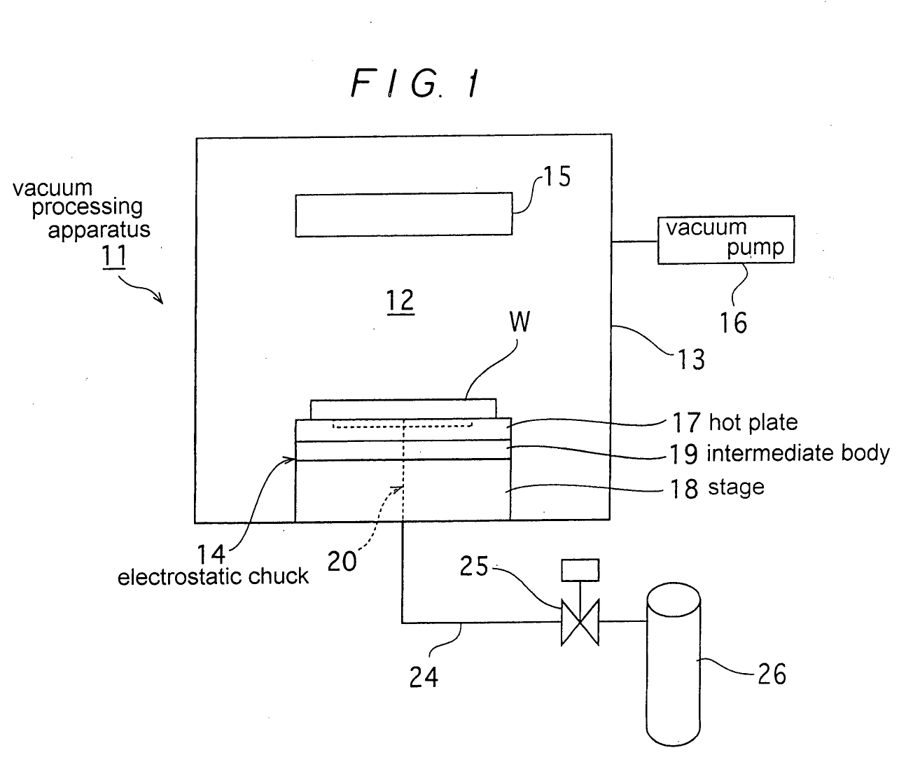

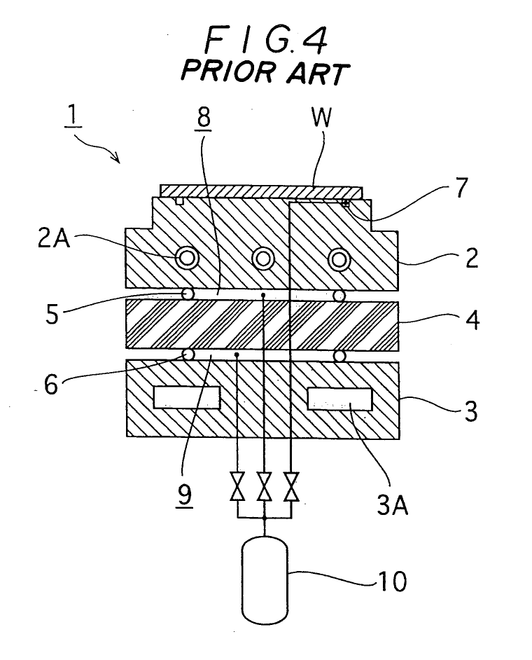

Next, the preferred embodiments of this invention will be described with reference to FIG. 1 to FIG. 4.

FIG. 1 is a schematic view of an outline of a vacuum processing apparatus with an electro-static chuck according to one embodiment of this invention. The vacuum processing apparatus 11 is provided with a vacuum tank 13 for forming a vacuum processing chamber 12, an electro-static chuck 14 arranged in the vacuum processing chamber 12 and a sputter target 15 for forming a film on a wafer supported on the electro-static chuck.

A vacuum exhaust or evacuate means such as a vacuum pump, although not shown, is connected to the vacuum processing chamber 13. Thus, the vacuum processing chamber 12 can be exhausted or evacuated to a predetermined pressure.

The sputter target 15 constitutes the vacuum processing means of this invention together with an introducing pipe for process gas (not shown), and a plasma generating source (not shown). In a film forming method other than the sputter method, for example, in a vacuum evaporation method, an evaporation source corresponds to the vacuum processing means of this invention. CVD method may be applied. This invention is not limited to the film-forming means, but may be applied to other vacuum processing means such as a dry-etching method and an ion implantation method.

The electrostatic chuck 14 is provided with a hot plate 17, a stage 18, an intermediate body 19 and a gas supply path 19. An electrode (not shown) for electrostatically attraction W and a heat mechanism such as heater (not shown) for heating the substrate W are assembled in the hot plate 17. The stage 18 has the finction to cool the hot plate 17. The intermediate body 19 is interposed between the hot plate 17 and the stage 18. The gas supply path 20 is formed in the hot plate 17, the intermediate body 19 and the stage 18 for supplying the heat transfer gas (Helium gas in this embodiment) to the surface of the hot plate 17.

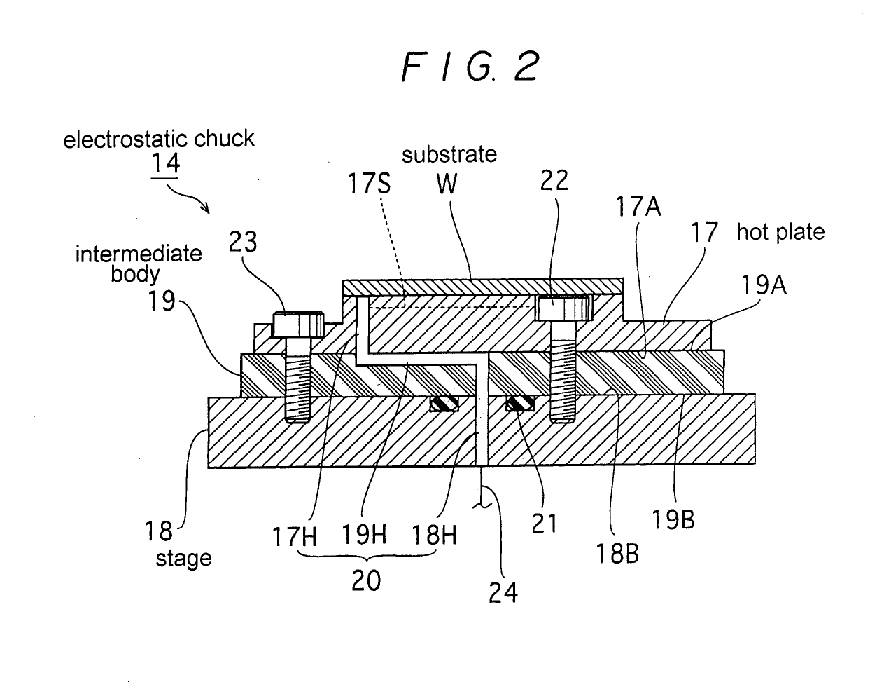

FIG. 2 is a schematic cross sectional view of the electrostatic chuck 14.

The hot plate 17 corresponds to the “plate” of this invention. It is made mainly of electric insulating material such as ceramics. As above-described, the electrode for electrostatically attracting the substrate and the heating mechanism are assembled in the hot plate 17. A vertical flow path portion 17H is formed in the hot plate 17, the upper end of which is open to the surface of the hot plate 17. The heat transfer gas is introduced onto the surface of the hot plate 17 and onto the back surface of the substrate W attracted to the hot plate 17.

Two dimensional grooves 17S are formed in the surface of the hot plate 17, communicating with the top end or opening of the flow path portion 17H. Thus, heat transfer gas is introduced into the radial directions of the back surface of wafer W. The surface of the hot plate 17 is made to be of a roughness such that some sealability can be obtained between the back surface of the substrate and the surface of the hot plate 17.

The stage 18 is the mount, which is made of metal such as stainless or an aluminum alloy. It is fixed through a vacuum seal member (not shown) on the bottom of the vacuum chamber 13. The circulation path of the cooling water (not shown) is made in the stage 18. It cools the wafer W and hot plate 17 through the intermediate body 19 to be further described hereinafter. A gas flow path 18H is vertically formed in the stage 18, constituting a part of the gas supply path 20.

Although not shown, a high voltage circuit is connected to the stage 16 for supplying electric power to the heating mechanism and the electrostatic chuck electrode assembled in the hot plate 17.

The intermediate body 19 is made of a material, which is endurable to the heat and has such a thermal conductivity ratio so as to transfer heat from the stage 18 to the hot plate 17 side and control the temperature of the substrate W. It may be both conductive and non-conductive. In accordance with the process, the above material can be selected from non-conductive material, for example, silica, carbonic silicon, aluminum, zirconia, ceramics etc., and can be selected from a conductive material, such as metal.

The gas supply path 20 consists of the vertical flow path 17H formed through and in the hot plate 17, a crank-shaped gas flow path 19H formed in the intermediate body 19 and a vertical gas flow path 18H formed in the stage 18.

The heat transfer gas is supplied into the electrostatic chuck 14 through the conduit 24 and the flow adjusting valve 25 from the tank 26 arranged outside of the vacuum processing chamber 13 as shown in FIG. 1. The conduit 24 is connected to the gas flow path 19H formed in the stage 18 of the electrostatic chuck 14. The heat transfer gas is supplied onto the back surface of the substrate W through the gas supply path 20. The seal finction for the heat transfer gas in the electrostatic chuck 14 can be obtained in the following manner:

First, an annular O-ring 21 is attached to the stage 18 so as to encircle the gas flow path 18H and seal between the intermediate body 9 and the stage 18. Since it is attached to the stage 18 which is cooled always by the cooling water, a desired seal finction can be maintained for a long time, because the O-ring 21 is made of elastic material such as rubber.

A predetermined seal function between the hot plate 17 and the intermediate body 19 is so designed as to be obtained by controlling the surface roughness of the contact surfaces. Thus, the back surface 17A of the hot plate 17 (the side surface of the intermediate body 19) and the surface 19A of the intermediate body 19 (the side surface of the hot plate 17 ) are so designed as to have a roughness less than 10 nm (Ra).

Thus, the contact surfaces are increased between the hot plate 17 and the intermediate body 19. Even when the electrostatic chuck 14 is used under the reduced pressure, little heating transfer gas leaks, since the predetermined sealing finction is between the hot plate 17 and the intermediate body 19.

The above sealing method can be employed also for the sealing between the stage 18 and the intermediate body 19. Thus, the surface 18B of the stage 18 (the side surface of intermediate body 19) and the back surface 19B of the intermediate body 19 (the side surface of the stage 18) are so designed as to have a roughness less than 10 nm (Ra).In this instance, the O-ring 21 may be omitted.

The hot plate 17, the intermediate body 19 and the stage 18 are joined together with each other through a jig means. In this embodiment, bolts 22 and 23 are used as the jig means. By fastening the bolts 22 and 23 at a predetermined torque, the sealing function can be secured between the hot plate 17 and the intermediate body 19 and between the intermediate body 19 and the stage 18. The fixing jig is not limited to the bolts 22 and 23, and another fixing jig, for example, a mechanical clamp, may be used.

The bolts 22 and 23 are fastened at one portion of the hot plate 17 within the absorbing area of the substrate W and at another portion of the hot plate 17 beyond the attracting area of the substrate W. Thus, thermal stress of the hot plate 17 occurring during the heating is relaxed.

In the above-described electrostatic chuck 14, the contact surfaces of the hot plate 17 and the intermediate body 19 are less than 10 nm in roughness. Thus, seal capacity for the heat transfer gas is improved between the hot plate 17 and the intermediate body 19. No seal means, which is endurable to the heat, is required between the hot plate 17 and the intermediate body 19. Thus, the electrostatic chuck 14 is simplified in construction. The cost is accordingly made low.

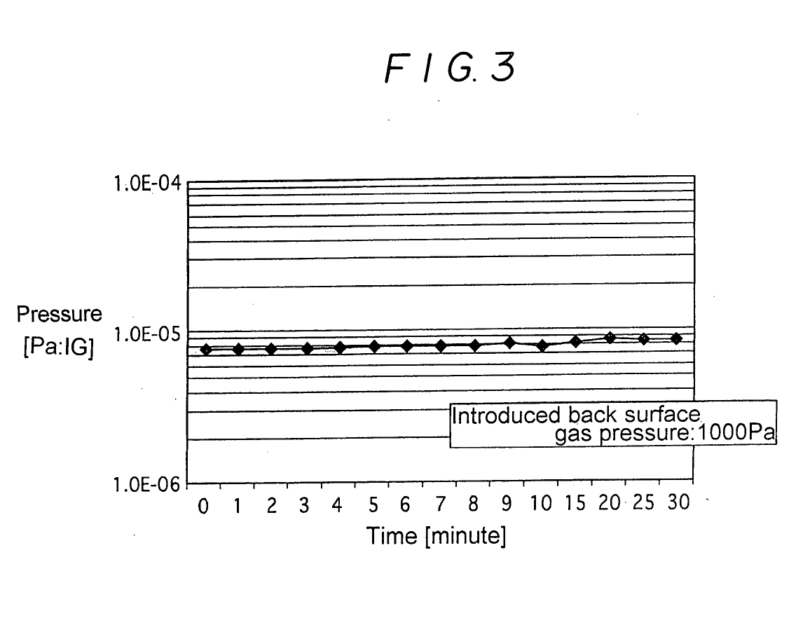

FIG. 3 shows the experimental data for measuring the leakage of the heat transfer gas through the contact surfaces (surface roughness 10 nm) of the hot plate 17 and the intermediate body 19, based on the time and the pressure of the processing chamber 12, which is monitored by the pressure monitor (ion gauge) arranged in the processing chamber 12. The pressure of the heat transfer gas supplied into the gas supply path 20 is equal to 1000 Pa (gauge pressure). The vacuum processing chamber 12 is exhausted or evacuated to near the pressure of 8×10⁻⁶ at the beginning of the measurement. Even after 30 minutes lapses from the beginning, the pressure changes little. It has been proved that the pressure of the vacuum processing chamber is stably maintained stably.

The electrostatic chuck 14 has little influence on process conditions such as a vacuum pressure. When the surface roughness accuracy of the contact surfaces of the hot plate 17 and 19 is further improved, it is inferred that sealability can be secured in higher vacuum conditions.

Further, in the electrostatic chuck 14 according to this embodiment, the hot plate 17, the intermediate body 19 and the stage 18 are joined together with each other by the bolts 22 and 23. Accordingly the hot plate 17 can be separately demounted and mounted. Thus, maintenance can be improved. In that case, the stage 18 is not required to be demounted. Accordingly, it is not necessary that the high voltage circuit for electric power supply and the cooling water supply system be disconnected from the stage 18. Accordingly, work and labor time can be decreased. Further, the rest time for vacuum processing apparatus 11 is increased.

Further since the intermediate body 19 is interposed between the stage 18 and the hot plate 17, deformation and damage to the hot plate 17 caused by the difference of the thermal expansion coefficients of the hot plate 17 and stage 18 can be avoided.

While the preferred embodiments have been described, variations thereto will occur to those skilled in the art within the scope of the present inventive concepts, which are delineated by the following claims.

For example, He gas is used as heat transfer gas in the above embodiment. However, argon or nitrogen gas may be used in accordance with this type of process.

Further, in the above embodiment, the sputtering apparatus is exemplified as the vacuum processing apparatus. However, it is not limited to that, and CVD apparatus, plasma etching apparatus or ion implantation apparatus are also applicable to this invention.

What is claimed is:

1. An electrostatic chuck for attracting a substrate comprising:
(A) a plate including an electrode for electrostatically attracting said substrate and a heating mechanism for heating said substrate;
(B) a stage for cooling said plate;
(C) an intermediate body interposed between said plate and said stage;
(D) a gas supply flow path formed in said plate, said intermediate body and said stage for supplying heat transfer gas to an exposed surface of said plate, and
(E) at least the contact surfaces of said plate and said intermediate body being less than 10 nm in surface roughness.

2. An electrostatic chuck according to claim 1 in which said intermediate body is made of insulating material.

3. An electrostatic chuck according to claim 1 in which said plate, said intermediate body and said stage are united with each other through fixing means.

4. An electrostatic chuck according to claim 3 in which said fixing means is at least one bolt.

5. An electrostatic chuck according to claim 1 in which an annular seal member is interposed between said intermediate body and said stage.

6. An electrostatic chuck according to claim 1 in which said stage includes a cooling water circulating path.

7. An electrostatic chuck according to claim 1 in which said stage is metal.

8. A vacuum processing apparatus comprising:
(A) a vacuum processing chamber;
(B) an electrostatic chuck arranged in said vacuum chamber for attracting a substrate;
(C) vacuum processing means for effecting a predetermined vacuum process to said substrate;
(D) said electrostatic chuck including:
(a) a plate including an electrode for electrostatically attracting said substrate and a heating mechanism for heating said substrate;
(b) a stage for cooling said plate;
(c) an intermediate body interposed between said plate and said stage;
(d) a gas supply flow path formed in said plate, said intermediate body and said stage for supplying heat transfer gas to an exposed surface of said plate, and
(e) at least the contact surfaces of said plate and intermediate body being smaller than 10 nm in surface roughness.
